(19) United States
(12) Patent Application Publication
(10) Pub. No.: US 2025/0084897 A1
(43) Pub. Date: Mar. 13, 2025

(54) Pivot Bearing, Pivot Lever Arrangement and Application Arrangement

(71) Applicant: KNORR-BREMSE Systeme fuer Nutzfahzeuge GmbH, Muenchen (DE)

(72) Inventors: Michael HIDRINGER, Winzer (DE); Thomas BECK, Neukirchen vorm Wald (DE); Andreas PETSCHKE, Neuburg am Inn (DE); Christian STOEGER, Osterhofen (DE); Maximilian HAUSER, Fuerstenzell (DE); Wolfgang PRITZ, Muenchen (DE); Ralf WEBER, Muenchen (DE)

(21) Appl. No.: 18/826,317

(22) Filed: Sep. 6, 2024

(30) Foreign Application Priority Data
Sep. 8, 2023 (DE) 10 2023 124 318.7

(51) Int. Cl. F16C 19/26; F16C 33/46; F16D 65/095

(52) U.S. Cl. CPC F16C 19/26; F16C 33/46; F16D 65/095; F16C 2361/45

(57) ABSTRACT

A pivot bearing supports a pivot lever of an application apparatus of a disc brake, wherein the pivot bearing has a curved bearing shell and a roller bearing cage which is pivotably guided thereon, wherein the roller bearing cage has at least one guiding vane which protrudes axially with respect to the pivot axis and which has at only one side an axially extending stop face for returning the roller member cage. A pivot lever arrangement and an application apparatus include the pivot bearing.

### CROSS REFERENCE TO RELATED APPLICATION

This application claims priority under 35 U.S.C. § 119 from German Patent Application No. 1020 23 124318.7, filed Sep. 8, 2023, the entire disclosure of which is herein expressly incorporated by reference.

### BACKGROUND AND SUMMARY

The present invention relates to a pivot bearing, a pivot lever arrangement and an application apparatus.

Pivot bearings are known from the prior art, for example, from DE 10 2004 031 792 A1 or from EP 3 129 668 B1, and corresponding pivot lever arrangements from EP 3 112 718 A1.

DE 10 2020 101 014 B3 also discloses a pivot bearing arrangement having a return member and a return counter-member which are connected to each other by means of a vane portion and a groove portion, wherein the vane portion rests in the groove. However, such a groove portion must be fitted to the pivot lever in a complex manner.

Based on this, an object of the present invention is to provide a return which is simpler and consequently also easier to produce.

The invention achieves this objective with the subject-matter of the independent claim(s).

A pivot bearing for supporting a pivot lever of an application apparatus of a disc brake, wherein the pivot bearing has a curved bearing shell and a roller bearing cage which is pivotably guided thereon, is in accordance with the invention.

The roller bearing cage has a guiding vane which protrudes axially with respect to the pivot axis. However, this guiding vane has at only one side an axially extending stop face for returning the roller member cage.

The single-sided return is based in contrast to the above-mentioned prior art on the recognition that a dual-sided return is not absolutely necessary, particularly since the pivot bearing additionally has an abutment stop which prevents over-pivoting of the bearing.

It is advantageous for the stop face to be in the form of an edge of the guiding vane. The stop of the guiding vane can thereby be permanently ensured in a stable manner.

It is further advantageous for the edge, which is opposite the stop face, of the guiding vane to be in the form of a vane reinforcement with a curved longitudinal extent. A deformation of the guiding vane is thereby additionally counteracted. At the same time, the guiding vane can be sized to be smaller.

The bearing shell may advantageously be in the form of a sheet metal strip, wherein the bearing shell extends over a continuous region of more than 80% of the longitudinal extent thereof in a curved plane. A particularly flat pivot bearing with little construction spatial requirement is thereby provided.

The bearing shell is advantageously in engagement with the roller member cage.

Preferably, the roller member cage has one or more locking elements, in particular one or more resilient locking bars, which is in engagement with a corresponding locking element of the bearing shell, in particular one or more recess grooves. The engagement may advantageously be carried out for the force distribution at both longitudinal sides of the bearing shell.

The guiding vane may advantageously be configured integrally with the roller member cage so that it has particular strength.

The roller member cage has bearing pockets for supporting roller members, in particular bearing needles, wherein the bearing pockets have for retaining the roller members retention webs which are arranged at only one side on a bearing pocket. This enables a simple rear insertion of the roller members in the needle bearing.

Furthermore, in accordance with the invention is a pivot lever arrangement comprising a pivot lever and a pivot bearing, preferably a pivot bearing according to the invention, wherein the pivot bearing has a curved bearing shell and a roller bearing cage which is pivotably guided thereon.

The roller bearing cage has a guiding vane which protrudes axially relative to the pivot axis, having a stop face, which together with a corresponding return element which is formed on the pivot lever, has a purely single-sided stop for returning the roller bearing cage.

The recognition according to which a single-sided stop is sufficient for return enables a substantial structural simplification of the pivot lever arrangement in comparison with the prior art.

For improved inherent stability against deformation, it is advantageous for the return element to be in the form of an increasingly tapering radial projection.

In a particularly preferred manner, the return element is a contour which extends out in a curved manner in the direction toward the tapered portion and which enables a guiding of the guide vane along the return element up to the end position of the stop. An overrunning or catching of the guiding vane on the return element has surprisingly not been produced.

The return element may advantageously be arranged at the end of a guiding face for guiding the pivot lever within a brake caliper and may preferably be configured in an integral, in particular monolithic, manner with the remainder of the pivot lever.

Specific advantages in the production process occur when the return element is in the form of a milling runout. A milling runout is easy for the person skilled in art to identify. It is located at the end of a mechanically processed surface. With reference to corresponding surface profilings which are formed in this instance, the reprocessing can be readily identified.

An application apparatus of a disc brake comprises a brake caliper and a pivot lever arrangement according to the invention, which is supported in a contour in the brake caliper.

The above-mentioned guiding face as part of the pivot lever may advantageously be part of or arranged adjacent to a guiding horn-like member which is introduced into a recess inside the brake caliper when the pivot movement is carried out. Consequently, the guiding faces perform the guiding within the recess.

Each side of the pivot lever may advantageously have only one lateral support of the bearing shell in the brake caliper, wherein the arrangement of the support locations are arranged diagonally with respect to each other.

A pivot bearing according to the invention, a pivot lever arrangement according to the invention, and an application apparatus according to the invention are explained in greater detail below with reference to the appended Figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a rear view of a pivot bearing according to an embodiment of the invention;

FIG. 2 shows a side view of the pivot bearing;

FIG. 3 shows a first perspective view of the pivot bearing;

FIG. 4 shows a second perspective view of the pivot bearing;

FIG. 5 shows a perspective view of a roller member cage of the pivot bearing of the preceding Figures;

FIG. 6a shows a plan view of a pivot lever for receiving the pivot bearing;

FIG. 6b shows a sectioned side view of the pivot lever of FIG. 6a;

FIG. 7 shows a perspective view of the pivot lever of FIGS. 6a and 6b;

FIG. 8a shows a plan view of a pivot lever arrangement according to the invention;

FIG. 8b shows a sectioned side view of the pivot lever arrangement of FIG. 8a;

FIG. 9 shows a perspective view of the pivot lever arrangement of FIGS. 8a and 8b;

FIG. 10 shows a sectioned illustration of an application apparatus according to an embodiment of the invention; and

FIG. 11 shows the sectioned view of FIG. 10 with a disassembled pivot lever.

### DETAILED DESCRIPTION OF THE DRAWINGS

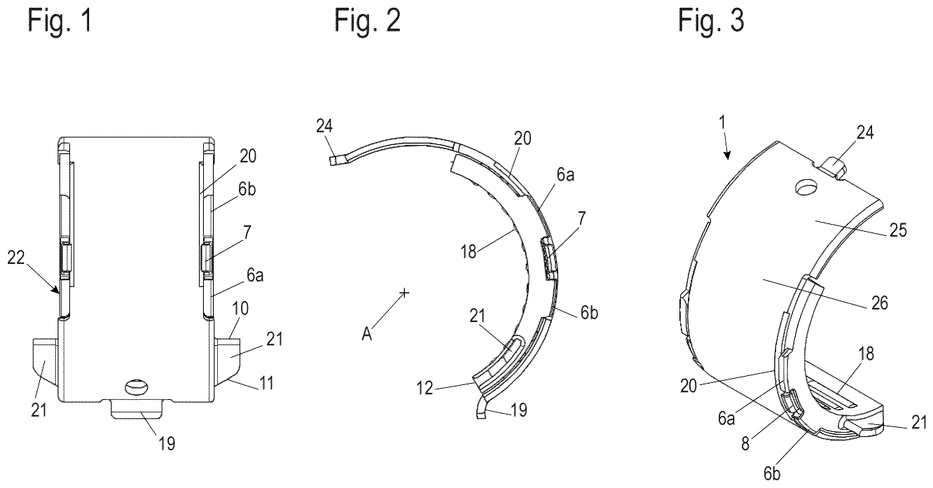

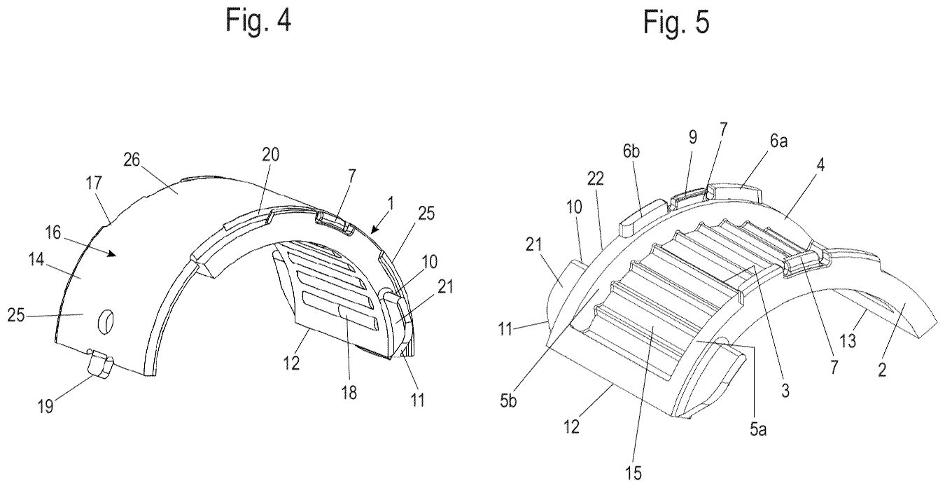

FIGS. 1 to 5 show in a detailed manner the pivot bearing 1 in an embodiment as a needle bearing for a disc brake which can be used in particular to support the above-described pivot lever which is also synonymously referred to as a rotary lever or brake lever, for example, on the brake caliper 51 of a disc brake, as known, for example, under the product names SN6 or SN7 or in a similar construction type, for example, from DE 4204307A (see the roller bearing 3 therein) or DE 197 31 696 A. With regard to the structure of such disc brakes which will otherwise not be explained here in greater detail, reference is made to the entire content of these documents. The pivot lever 1 has a pivot axis A.

The pivot bearing 1, which is illustrated in FIGS. 1 to 5 and which is in the form of a needle or roller bearing, has a circular-arc-like bearing shell 16 and a roller member cage 2 which can be pivoted relative thereto, between which a set of roller members 18, in this instance in the form of bearing needles, is arranged in such a manner that the bearing shell 16 is movably supported relative to the roller member cage 2 on roller members, in particular supported on rollers.

The roller member cage 2 may preferably comprise plastics material and is provided with two lateral side edges 5a, 5b which are outwardly orientated perpendicularly to the roller member cage and which have guiding faces directed toward the bearing needles 18. The opposing side edges 5a, 5b together define with two opposing end edges, which each have the front end faces 12 and 13 of the roller member cage, a receiving space for the bearing needles 18. The receiving space is subdivided into bearing pockets 4, which are defined at one side by means of retention webs 3 which extend parallel with the pivot axis A between the side edges 5a, 5b. The retention webs 3 prevent the roller members 18, for example, the bearing needles, from falling out internally in a radial direction when the pivot bearing 1 is mounted. At the rear side, falling out is prevented by the bearing shell 16.

Guiding elements 6a and 6b extend from the side edges 5a, 5b parallel therewith, for example, in the form of curved projections. The guiding elements 6a and 6b extend in the direction of the bearing shell 16 and enclose it laterally in a U-shape. In addition to the guiding elements 6a and 6b which protrude from a side edge 5a, 5b, a locking element 7, for example, a locking bar 9, protrudes from the side edges 5a, 5b and engages behind the bearing shell 16 and consequently engages with the roller member cage.

The bearing shell 16 has to this end as a corresponding locking element along the edge faces recess grooves 20 in which the locking bar 9 engages.

From the outer face 22 of the side edges 5a, 5b, at least one guiding vane 21 protrudes in an axial direction (with respect to the pivot axis A). This guiding vane 21 is characterized by only one stop face 10 in axial extent. A corresponding return element 34 of the brake or pivot lever 30 may be arranged at this location. The edge opposite the stop face 10 is in the form of a curved vane reinforcement 11 and, as a result of the curved shape, does not enable a positionally precise and repeatable stop of the above-mentioned return element 34. The stop face 10 meanwhile enables the conjoint guiding of the roller member cage in a pivot direction, whilst the guiding in the opposite direction can be carried out by means of another stop, for example, against the end face 12 or the like. One advantage is the substantially smaller risk of a mechanical deformation of the guiding vane as a result of the reduced mechanical loading and a result of the vane reinforcement 11.

The bearing shell 16 may be produced from a planar metal sheet which has been bent to form a cylindrical portion or into the form of a circular arc. This is tribologically non-sensitive as a result of the material selection. It has at the two sides thereof two central recesses 17, in particular narrowed portions, in which the locking bars 9 of the roller member cage engage, wherein the narrowed portions 17 have such an extent that the roller member cage 2 is guided in the narrowed portions 17 of the bearing shell 16 so as to be movable in a limited manner so that the recesses 17, on the one hand, in a simple manner take on the function of movement-limiting stops and, on the other hand, guide the bearing shell 16 on the roller member cage 2 in an effective manner and retain it in the installation situation. The recess grooves 20 have in this instance at least one similarly long or longer circular-arc-like extent with respect to the narrowed portions 17.

As a result of the narrowed portions, the bearing shell is subdivided into two curved end segments 25 and into a similarly curved central segment 26.

Securing devices, such as projections 19, 24 and/or holes, fix the roller member cage 2 and/or the bearing shell 16 to the respective associated components which are intended to be supported so as to be movable relative to each other, such as the brake caliper 51 and the pivot lever 30 of the disc brake.

The roller member cage 2 made of plastics material has a central opening 15, having a plurality of recess-like bearing pockets 4 for receiving one, preferably in each case two, of the roller members 18 in the form of a bearing needle. The bearing shell 16 comprises in contrast a metal sheet which can be produced with the exception of the projections 19, 24 in a simple manner in only one bending process so that the pivot bearing according to the invention without any limitation of function can be produced in a significantly more cost-effective manner than comparable pivot bearings.

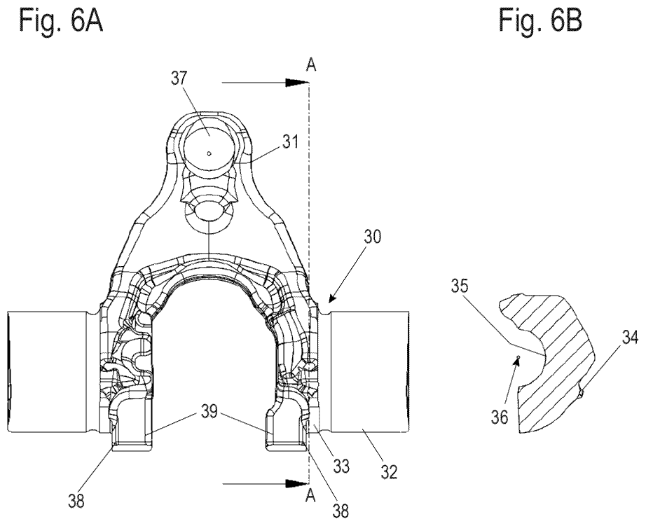

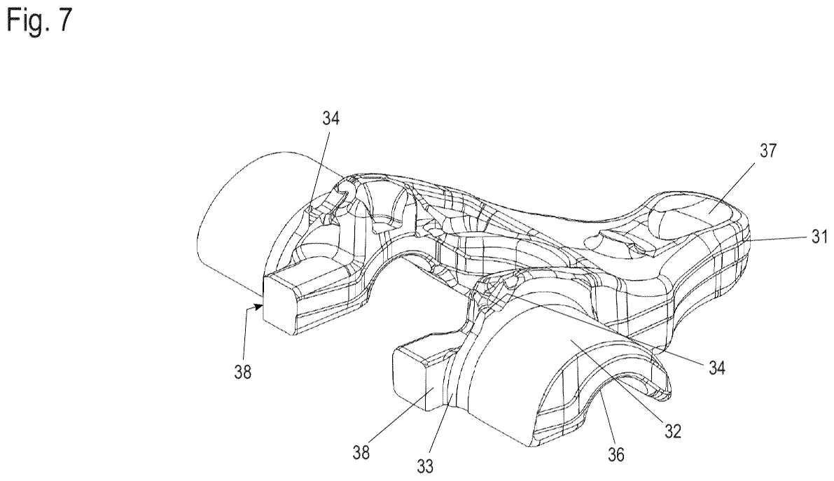

FIGS. 6a, 6b and 7 show a pivot lever 30 which is configured for the arrangement of two above-described pivot bearings. Therefore, the pivot lever has a lever element 31 and with a terminal dome-shaped receiving member 37 for receiving a tappet which is not illustrated, for example, of a pneumatic cylinder. Furthermore, the pivot lever 30 has two vane-like bearing jaws each having a bearing face 32 for supporting one of the pivot bearings 1 in each case.

In this instance, the pivot lever 30 defines a rotation axis 36 which, as a result of an inner bearing face 35 for pivotable bearing, bears on an axial leg inside a brake caliper 51 and which is located coaxially with respect to the pivot axis A of the pivot bearing 1.

In a state adjacent to the bearing face 32, the pivot lever has a running path 33 along which the guiding vane 21 extends. In a state adjacent to this running path 33 there is in each case a guiding face 38 which is arranged laterally on a guiding horn-like member 39 and which extends parallel over only a part-region of the curved form of the bearing face 32, preferably between 20 and 70% of the curved form.

The guiding face runs out at a return element 34 as a corresponding stop with respect to the guiding vane 21. The pivot lever 30 has in addition other functional elements which, however, in the context of the bearing and the arrangement of the pivot bearing are not of primary importance.

In order to provide the mentioned guiding faces 38, a material-removal processing operation of a provided pivot lever, for example, as a forged component or a cast component or the like, can be carried out so that the pivot lever with a configuration according to FIGS. 6a, 6b and 7 is provided.

The construction of the guiding faces 38 of the guiding horn-like members 39 may, for example, be carried out by means of a grinding or milling operation, in particular by means of circular milling.

In this instance, a milling runout typically remains and must be removed by means of a reprocessing operation. This milling runout is in this instance the return element 34. Consequently, the return element is a radial projection with a curved contour which, as a result of its configuration as a milling runout, tapers increasingly from the beginning to the upper edge thereof. As has surprisingly also been found, the guiding vane 21 does not become caught on this type of return element. Instead, the return element is additionally stabilized against deformation by the gradual tapering in a radial direction.

As can already be seen in FIGS. 1 to 7, the stop between the return element 34 and the guiding vane 21 is purely one-sided.

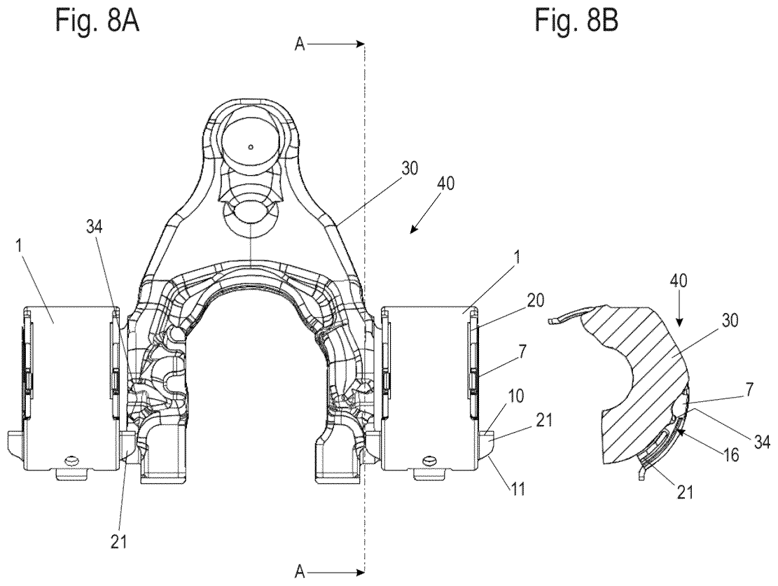

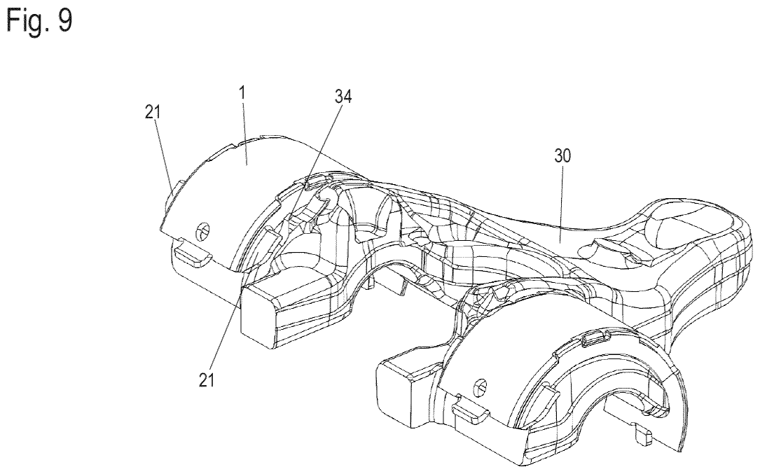

FIGS. 8a, 8b and 9 show this single-sided stop in detail. The illustrated pivot lever arrangement 40 according to the invention comprising the pivot lever 30 and the pivot bearing 1 is configured in such a manner that the pivot lever 30 can be positioned in a pivotable manner on a fixed counter-bearing by means of the pivot bearing 1. Whilst the pivotability is limited as a result of the engagement between the locking means 7 and the corresponding recess groove 20 and the length thereof. An end stop is additionally not achieved in any case since the cage can follow behind the pivot movement of the pivot lever.

The return element 34 acts in cooperation with the pivot lever 30 in particular also as a rattle prevention means and prevents a displacement of the bearing.

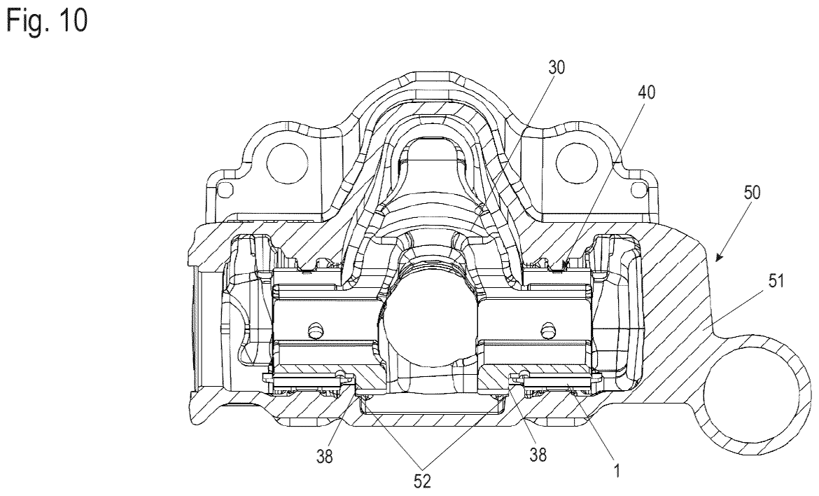

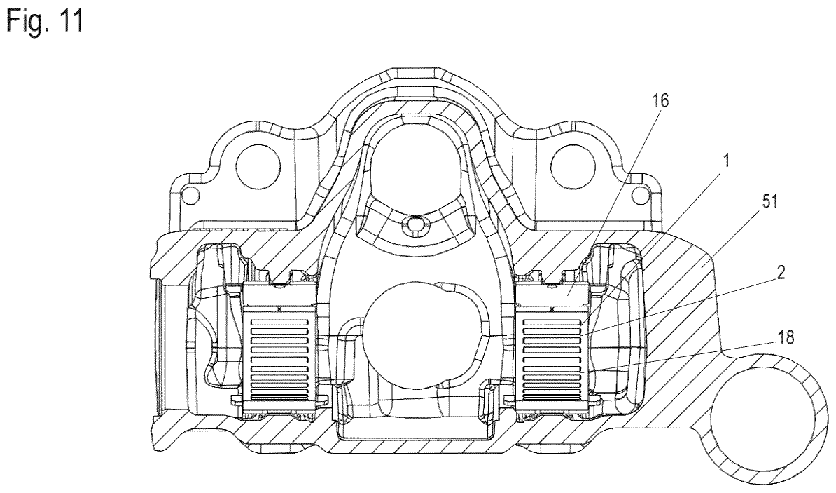

FIGS. 10 and 11 then disclose an application apparatus 50 according to the invention of a disc brake. The application apparatus comprises a brake caliper 51 and the above-described pivot lever arrangement 40 which is inserted therein and which comprises a pivot lever 30 and a pivot bearing 1.

In the brake caliper 51, one or more of the axle members which are concealed in the Figures is/are arranged. Furthermore, a recess 52 for receiving the guiding horn-like members 39 during the pivot movement is arranged in the brake caliper 51. The recess 52 has peripheral guiding faces which correspond to the guiding faces 38 and thereby secure the pivot lever 30 when carrying out the movement into the position thereof.

Some specific features of the present invention will be described again in detail below.

Consequently, the guiding vane 21 functionally has a return stop which is not in the form of a groove, but is instead in the form of a stop face 10.

This is a stop face 10 which is constructed only at one side on the guiding vane 21, preferably having a longitudinal extent parallel with the pivot axis 36 of the pivot bearing 1.

The counter-stop which corresponds to the stop face 10 on the pivot lever 30 forms the return element 34 which enables the purely single-sided stop of the return. This return element 34 may be configured with the least complexity by the end of a free milling, in particular by means of processing by circular milling. However, a formation without processing by means of milling or by attachment of an additional component on the pivot lever would also be conceivable.

The above-described return element is in a particularly preferred manner integrated directly in the pivot lever, as a result of the combination of lateral lever guiding by means of guiding faces for the brake caliper and use of the run-out of the guiding faces for the return of the pivot bearing cage.

Consequently, no additional component is required on the lever for the cage return.

Conversely, the return via the guiding vane may be integrated directly in the cage.

As a result of the purely single-sided stop, the face, which is opposite the stop face 10, of the guiding vane 21 may be in the form of a backwardly tapering reinforcement, which on the whole enables an additional stability of the return.

The retention webs 3 of the pivot bearing are further fitted only at one side, which means a structural simplification, and a simplification in the production of the pivot bearing, in particular with a plastics material injection-molding operation.

The locking bars 9 for ensuring the connection of the roller member cage 2 to the roller members 18 and bearing shell 16 are preferably in the form of a resilient undercut, that is to say, resilient snap-fitting projections.

The pivot lever 30 is configured at both sides with one of the above-described roller member bearings. In this instance, according to FIGS. 10 and 11 each side has only one lateral support of the bearing shell 16 in the brake caliper 51, wherein the arrangement of the support locations are arranged diagonally with respect to each other.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Pivot bearing
2 Roller member cage
3 Retention web
4 Bearing pocket
5a Side edges
5b Side edges
6a Guiding element
6b Guiding element
7 Locking element
9 Locking bar
10 Stop face
11 Vane reinforcement
12 End face
13 End face
15 Recess
16 Bearing shell
17 Recesses
18 Roller member
19 Projection
20 Recess grooves
21 Guiding vanes
22 Outer face
24 Projection
25 End segment
26 Central segment
30 Pivot lever
31 Lever element
32 Bearing face
33 Running path
34 Return element
35 Inner bearing face
36 Rotation axis
37 Receiving member
38 Guiding face
39 Guiding horn-like member
40 Pivot lever arrangement
50 Application apparatus
51 Brake caliper
52 Recess
A Pivot axis

What is claimed is:

1. A pivot bearing for supporting a pivot lever of an application apparatus of a disc brake, comprising:
a curved bearing shell; and
a roller bearing cage which is pivotably guided on the curved bearing shell, wherein
the roller bearing cage has at least one guiding vane which protrudes axially with respect to a pivot axis and which has, at only one side, an axially extending stop face for returning the roller member cage.

2. The pivot bearing according to claim 1, wherein
the stop face is formed as an edge of the guiding vane.

3. The pivot bearing according to claim 2, wherein
another edge, which is opposite the stop face, of the guiding vane, is a vane reinforcement with a curved longitudinal extent.

4. The pivot bearing according to claim 1, wherein
the bearing shell is a sheet metal strip, and
the bearing shell extends over a continuous region of more than 80% of a longitudinal extent thereof in a curved plane.

5. The pivot bearing according to claim 1, wherein
the bearing shell is in engagement with the roller member cage.

6. The pivot bearing according to claim 5, wherein
the roller member cage has one or more locking elements which is/are in engagement with one or more corresponding locking elements of the bearing shell.

7. The pivot bearing according to claim 6, wherein
the one or more locking elements are resilient locking bars, and
the one or more corresponding locking elements are one or more recess grooves.

8. The pivot bearing according to claim 1, wherein
the guiding vane is configured integrally with the roller member cage.

9. The pivot bearing according to claim 1, wherein
the roller member cage has bearing pockets for supporting roller members,
the bearing pockets have, for retaining the roller members, retention webs which are arranged at only one side on a bearing pocket.

10. The pivot bearing according to claim 9, wherein the roller members are bearing needles.

11. A pivot lever arrangement, comprising:
a pivot lever having a return element; and
a pivot bearing having a curved bearing shell and a roller bearing cage which is pivotably guided thereon, wherein
the roller bearing cage has a guiding vane which protrudes axially relative to a pivot axis,
the guiding van has a stop face which, together with the corresponding return element formed on the pivot lever, has a purely single-sided stop for returning the roller bearing cage.

12. The pivot lever arrangement according to claim 11, wherein
the return element is in the form of an increasingly tapering radial projection.

13. The pivot lever arrangement according to claim 12, wherein
the return element has a contour which runs out in a curved manner toward the tapered portion.

14. The pivot lever arrangement according to claim 11, wherein
the return element is arranged at an end of a guiding face for guiding the pivot lever within a brake caliper and is configured in an integral monolithic manner with a remainder of the pivot lever.

15. The pivot lever arrangement according to claim 11, wherein
the return element is in the form of a milling runout.

16. An application apparatus of a disc brake, comprising:
a brake caliper; and
a pivot lever arrangement according to claim 11, which is supported in a contour in the brake caliper.

17. The application apparatus according to claim 16, wherein
the guiding face is part of or is arranged adjacent to a guiding horn-shaped member which is introduced into a recess inside the brake caliper when the pivot movement is carried out.

18. The application apparatus according to claim 16, wherein
each side of the pivot lever has only one lateral support of the bearing shell in the brake caliper,
wherein an arrangement of the support locations is diagonally with respect to each other.
